(19) United States
(12) Patent Application Publication
(10) Pub. No.: US 2020/0341123 A1
(43) Pub. Date: Oct. 29, 2020

(54) LIGHT DETECTOR

(71) Applicant: Shenzhen Genorivision Technology Co. Ltd., Shenzhen (CN)

(72) Inventors: Peiyan CAO, Shenzhen (CN); Yurun LIU, Shenzhen (CN)

(21) Appl. No.: 16/924,352

(22) Filed: Jul. 9, 2020

Related U.S. Application Data
(63) Continuation of application No. PCT/CN2018/074259, filed on Jan. 26, 2018.

(51) Int. Cl. G01S 7/481

(52) U.S. Cl. CPC G01S 7/4816; G01S 7/4814; G01S 7/4817

(57) ABSTRACT

An apparatus, comprising: a light source configured to generate a primary light beam that diverges along a first dimension to illuminate a line in a target scene, and diffracted light beams that diverge along the first dimension and spaced apart from the primary light beam in a second dimension perpendicular to the first dimension; wherein the light source is configured to scan the light beam in the second dimension; a detector comprising a first plurality of light receiving components configured to detect light of the primary light beam returned from the target scene, and a second plurality of light receiving components configured to detect light of the diffracted light beams returned from the target scene.

### TECHNICAL FIELD

The disclosure herein relates to light detectors, particularly relates to a light detector that can detect scanning primary light and diffracted light.

### BACKGROUND

Lidar is a laser-based method of detection, range finding and mapping. There are several major components to a lidar system: laser source, scanner and optics, photo detectors and receiver electronics. For example, controlled steering of scanning laser beams is carried out, and by processing the captured return signals reflected from distant objects, buildings and landscapes, distances and shapes of these objects, buildings and landscapes may be obtained.

Lidar system is widely used. For example, autonomous vehicles (e.g., driverless cars) use lidar (also known as on-vehicle lidar) for obstacle detection and collision avoidance to navigate safely through environments. An on-vehicle lidar is mounted on the roof of a driverless car and it rotates constantly to monitor the current environment around the car. The lidar sensor provides the necessary data for software to determine where potential obstacles exist in the environment, help identify the spatial structure of the obstacle, distinguish objects based on size and estimate the impact of driving over it. One advantage of the lidar systems compared to radar systems is that the lidar systems can provide better range and a large field of view, which helps detecting obstacles on the curves. Despite tremendous progress has been made in developing lidar systems in recent years, a lot of efforts are still being made these days to design lidar systems for various application needs, including developing new light sources that can perform controlled scanning, and developing new detectors that can detect diffracted light beams to improve return signal detection.

### SUMMARY

Disclosed herein is an apparatus, comprising: a light source configured to generate a primary light beam that diverges along a first dimension to illuminate a line in a target scene, and diffracted light beams that diverge along the first dimension and spaced apart from the primary light beam in a second dimension perpendicular to the first dimension; wherein the light source is configured to scan the primary light beam in the second dimension; a detector comprising a first plurality of light receiving components configured to detect light of the primary light beam returned from the target scene, and a second plurality of light receiving components configured to detect light of the diffracted light beams returned from the target scene.

According to an embodiment, the first plurality of light receiving components are arranged in a first column and the second plurality of light receiving components are arranged in a second column; wherein the first column is parallel to the second column.

According to an embodiment, each of the light receiving components is square in shape.

According to an embodiment, the first plurality of light receiving components are configured to generate first electrical signals based on the light of the primary light beam returned from the target scene; wherein the second plurality of light receiving components are configured to generate second electrical signals based on the light of the diffracted light beams returned from the target scene.

According to an embodiment, the apparatus further comprises a signal-processing unit configured to process and analyze the first electrical signals and second electrical signals.

Disclosed herein is an apparatus, comprising: a light source configured to generate a primary light beam to illuminate a spot in a target scene, and diffracted light beams spaced apart from the primary light beam in a first dimension or a second dimension that is perpendicular to the first dimension; wherein the light source is configured to scan the primary light beam in the first dimension and the second dimension; a detector comprising a first light receiving component configured to detect light of the primary light beam returned from the target scene, and a plurality of second light receiving components configured to detect light of the diffracted light beams returned from the target scene.

According to an embodiment, the plurality of second light receiving components surround the first light receiving component.

According to an embodiment, the first light receiving component is configured to a generate first electrical signal based on the light of the primary light beam returned from the target scene; wherein the plurality of second light receiving components are configured to generate second electrical signals based on the light of the diffracted light beams returned from the target scene.

According to an embodiment, the apparatus further comprises a signal-processing unit configured to process and analyze the first electrical signals and the second electrical signals.

According to an embodiment, the light source comprises a light emitter and a light scanning element, wherein the light scanning element is configured to receive light from the light emitter and generate the primary light beam, wherein the light scanning element is configured to scan the primary light beam in the first dimension or in the second dimension.

According to an embodiment, the light scanning element comprises a plurality of optical waveguides and an electronic control system; wherein the plurality of optical waveguides each comprise an input end, an optical core and an output end, the output ends of the plurality of optical waveguides arranged to line up in the second dimension; wherein the electronic control system configured to adjust dimensions of the optical cores of the plurality of optical waveguides by regulating temperatures of the optical cores of the plurality of optical waveguides; wherein by adjusting the dimensions of the optical cores of the plurality of optical waveguides the electronic control system is configured to control phases of output light waves from the plurality of optical waveguides for the output light waves to form the primary light beam and scan the primary light beam in the second dimension.

According to an embodiment, at least one optical core comprises an optical medium that is conductive and transparent.

According to an embodiment, the at least one optical core is electronically connected to the electronic control system, wherein the electronic control system is configured to control the temperature of at least one optical core by applying an electric current flowing through the at least one optical core.

According to an embodiment, at least one of the plurality of optical waveguides further comprises a conductive cladding around sidewalls of a respective optical core.

According to an embodiment, the conductive cladding is electronically connected to the electronic control system, wherein the electronic control system is configured to control the temperature of the respective optical core by applying an electric current flowing through the conductive cladding.

According to an embodiment, the light scanning element further comprises a temperature modulation element electrically connected to the electronic control system, where in the electronic control system is configured to control the temperature of at least one optical core by adjusting the temperature of the temperature modulation element.

According to an embodiment, the temperature modulation element and the plurality of optical waveguides are formed on a common substrate.

According to an embodiment, the plurality of optical waveguides is formed on a surface of a common substrate.

According to an embodiment, at least one optical waveguide is curved.

According to an embodiment, at least one of the plurality of optical waveguides is on one substrate and at least another of the plurality of optical waveguides is on a separated substrate.

### BRIEF DESCRIPTION OF FIGURES

FIG. 1 schematically shows a perspective view of an apparatus suitable for light scanning and diffracted light detection, according to an embodiment.

FIG. 2A schematically shows a top view of a light source, according to one embodiment.

FIG. 2B and FIG. 2C schematically show front view of light source emitting apertures, and resulting diffraction patterns, according to another embodiment.

FIG. 3 schematically shows a top view of the apparatus comprising a light source, a target scene, an optical device, and a detector, according to an embodiment.

FIG. 4A and FIG. 4B schematically show a top view of the detector, with a plurality of light receiving components, according to one embodiment.

FIG. 5 schematically shows a cross-sectional view of the detector, with light receiving components and signal-processing units, according to one embodiment.

FIG. 6A and FIG. 6B each schematically show a component diagram of the detector of FIG. 5.

FIG. 7A schematically shows a perspective view of a light steering component, according to one embodiment.

FIG. 7B schematically shows a cross-sectional view of the light steering component, according to one embodiment.

FIG. 7C schematically shows a cross-sectional view of the light steering component, according to another embodiment.

FIG. 7D schematically shows a cross-sectional view of the light steering component, according to an embodiment.

### DETAILED DESCRIPTION

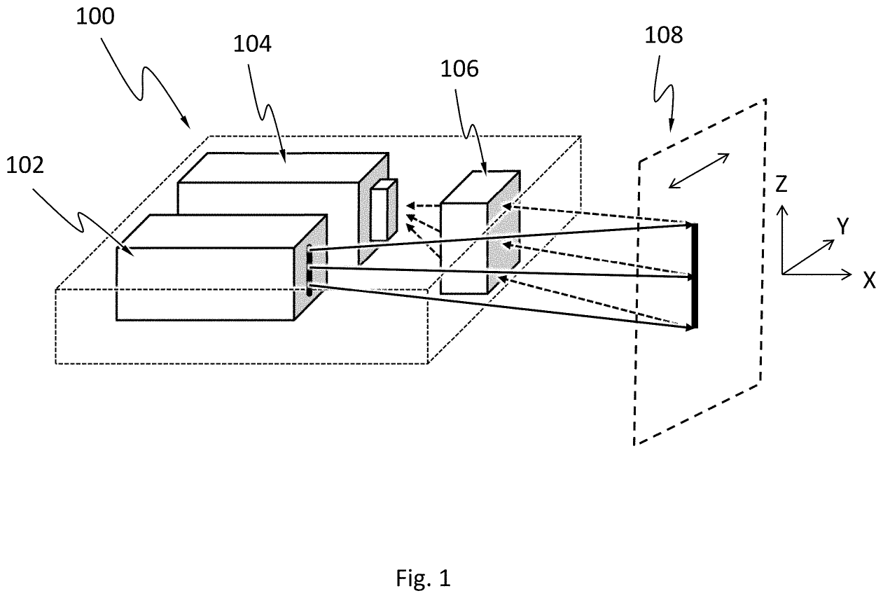

FIG. 1 schematically shows an apparatus 100 suitable for light scanning and diffracted light beam detection, according to an embodiment. The apparatus 100 may comprise a light source 102, a detector 104 and an optical device 106.

The light source 102 may be configured to generate a primary light beam that diverges along a first dimension (the Z dimension here) to illuminate a line along the first dimension in a target scene 108. The light source 102 may be further configured to scan the primary light beam in a second dimension (the Y dimension here) that is perpendicular to the first dimension.

According to an embodiment, the light source 102 may be configured to generate a primary light beam to illuminate a spot in the target scene 108. The light source 102 may be further configured to scan the primary light beam in the first dimension and the second dimension that is perpendicular to the first dimension.

The optical device 106 may be configured to converge return light waves reflected off the target scene 108 to generate converged return light waves. The optical device 106 may be positioned between the detector 104 and the target scene 108.

The detector 104 may comprise a light receiving component. The light receiving component may be configured to receive the converged return light waves, and the detector 104 may be configured to detect the converged return light waves incident on the light receiving component. In one embodiment, the detector 104 may be configured to generate electrical signals based on the converged return light waves detected. The apparatus 100 may further comprise a signal-processing unit configured to process and analyze the electrical signals.

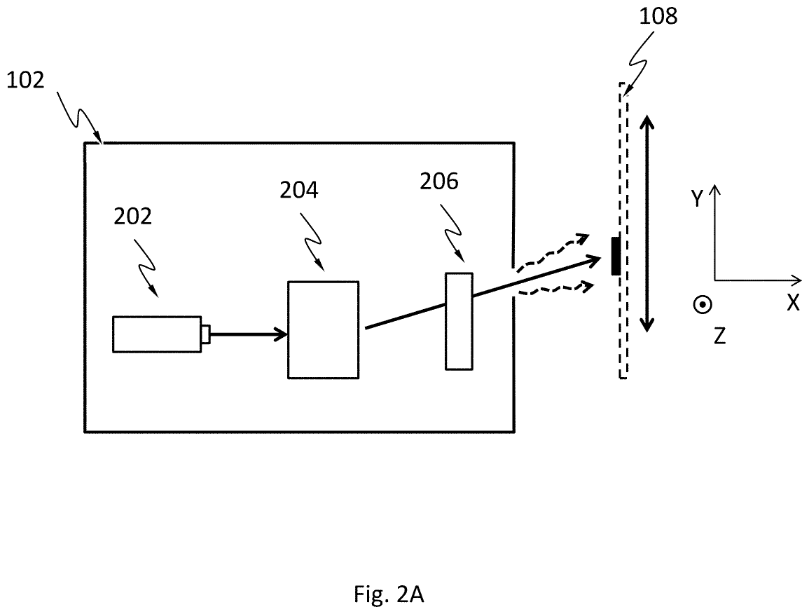

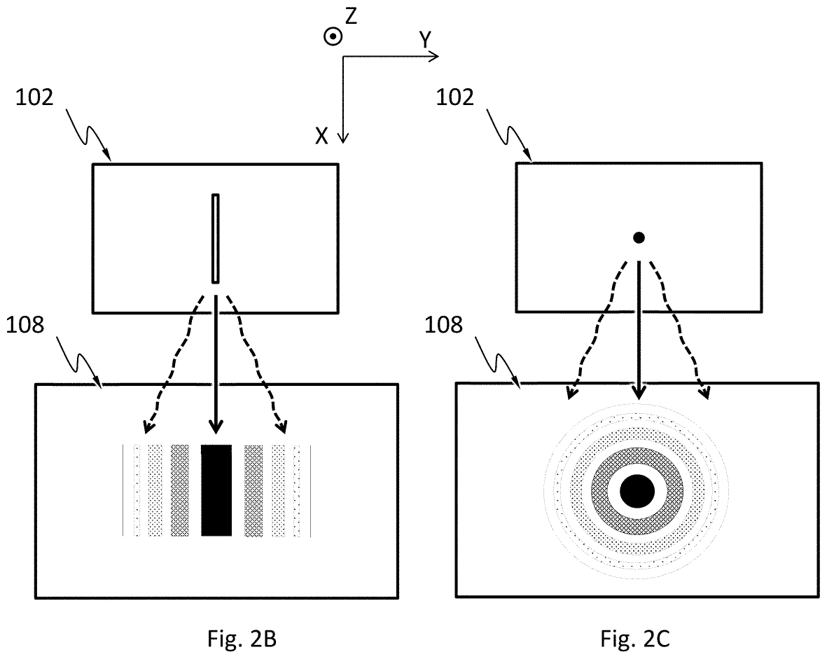

FIG. 2A schematically shows the light source 102, according to an embodiment. The light source 102 may comprise a light emitter 202, a light steering component 204 and an optical component 206. In an embodiment, the light emitter 202 may be a laser source. The light steering component 204 may be configured to receive an input light beam from the light emitter 202, generate a primary light beam and steer the primary light beam in the second dimension (the Y dimension here). The optical component 206 may be configured to diverge the primary light beam from the light steering component 204 in the first dimension (the Z dimension here) so that the primary light beam illuminates a line along the first dimension in the target scene 108. As shown in FIG. 2A, the optical component 206 may be positioned between the light steering component 204 and the target scene 108. Alternatively, the light steering component 204 may be positioned between the optical component 206 and the target scene 108. In an embodiment, the optical component 206 may comprise a one-dimensional diffraction grating or a cylindrical lens. Due to the wave nature of light, diffraction of the primary light beam may occur when the primary light beam leaves the light source 102 (e.g., from an aperture), as shown in FIG. 2A according to an embodiment. Diffracted light beams may travel along with the primary light beam, and may reach and get reflected by the target scene 108. Depending on the characteristics (e.g., shape of the aperture) of the light source 102, different patterns of the diffracted light beams may be observed in the target scene 108, as shown in FIG. 2B and FIG. 2C. In an example where the aperture is a single slit, the pattern may be a series of lines as schematically shown in FIG. 2B. In an example where the aperture is a single hole, the pattern may be a series of concentric rings and a dot as schematically shown in FIG. 2C.

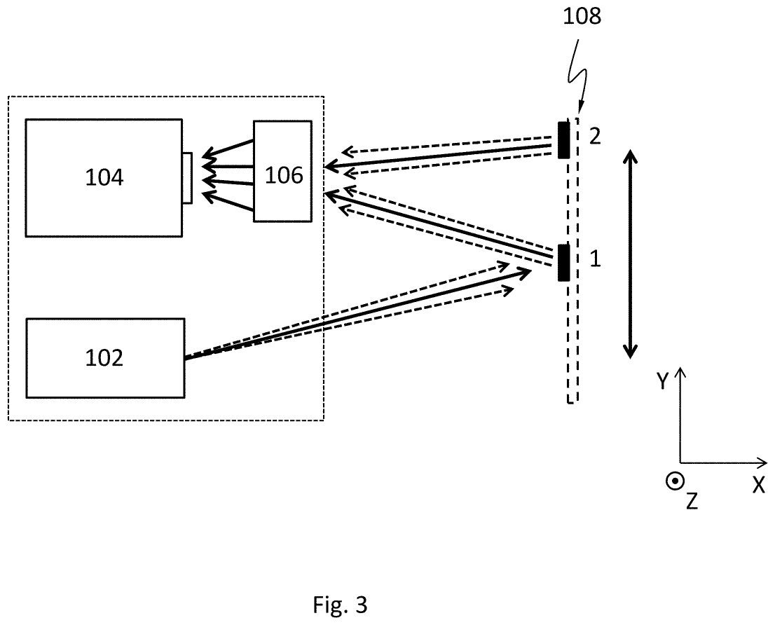

FIG. 3 schematically shows a top view of the apparatus 100, according to an embodiment. When the light source 102 emits the primary light beam from a single slit aperture, the primary light beam and diffracted light beams may each illuminate a line near a first position (Position 1 in FIG. 3) on the target scene 108. The primary light beam and diffracted light beams may be reflected by the target scene 108, and the return light waves from the illuminated lines at the first position may hit the optical device 106. The optical device 106 may converge the return light waves incident thereon in the Y dimension and in the Z dimension so that the converged return light waves are within the detection range of the detector 104 and received by the light detecting elements of the detector 104.

When the light source 102 steers the primary light beam in the Y dimension and the lines illuminated by the primary light beam and the diffracted light beams on the target scene 108 moves from the first position to a second position (Position 2 in FIG. 3), the return light waves from the lines illuminated by the primary light beam and the diffracted light beams near the second position may hit the optical device 106, along angles different from the return light waves from the lines illuminated by the primary light beam and the diffracted light beams near the first position. The optical device 106 may also converge the return light waves from the lines illuminated by the primary light beam and the diffracted light beams near the second position incident thereon in the Y dimension and in the Z dimension so that the converged return light waves from the lines illuminated by the primary light beam and the diffracted light beams near the second position are also within the detection range of the detector 104 and received by the light detecting elements of the detector 104.

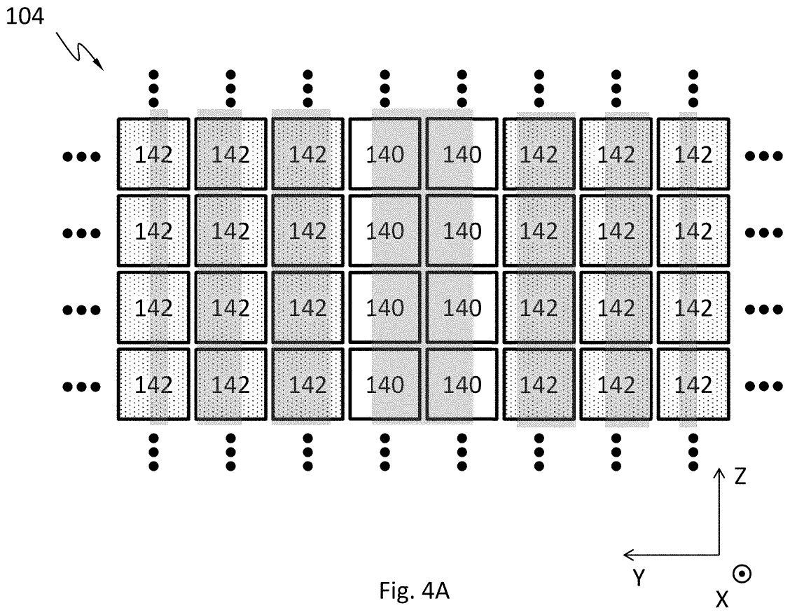

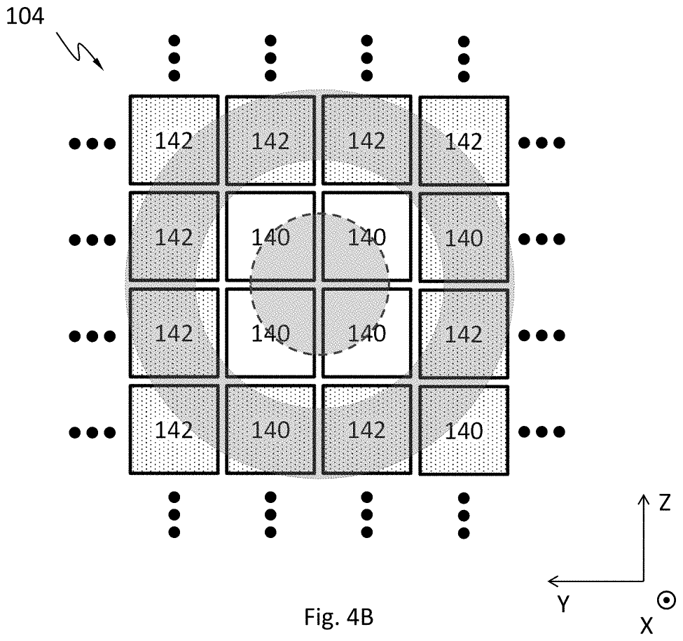

FIG. 4A schematically shows a top view of the detector 104, for the light source 102 with a single slit aperture, according to one embodiment. The detector 104 may comprises a first plurality of light receiving components 140, which are configured to detect light of the primary light beam returned from the target scene, and a second plurality of light receiving components 142, which are configured to detect light of the diffracted light beams returned from the target scene 108. The first plurality of light receiving components 140 may be arranged in a first column and the second plurality of light receiving components 142 may be arranged in a second column. The first column may be parallel to the second column. There may be one or more first columns of light receiving components 140 between two neighboring second columns of light receiving components 142, as shown in FIG. 4A. Each of the light receiving component may be square in shape. A part of the pattern of the diffracted light beams of FIG. 2B is superimposed onto the light receiving components 140 and 142.

FIG. 4B schematically shows a top view of the detector 104, for the light source 102 with a single hole aperture, according to another embodiment. The detector 104 may comprises a first plurality of light receiving components 140, which are configured to detect light of the primary light beam returned from the target scene, and a second plurality of light receiving components 142, which are configured to detect light of the diffracted light beams returned from the target scene 108. The first plurality of light receiving components 140 may be surrounded by the second plurality of light receiving components 142. There may be one or more first light receiving components 140 surrounded by second light receiving components 142, as shown in FIG. 4B. Each of the light receiving component may be square in shape. A part of the pattern of the diffracted light beams of FIG. 2C is superimposed onto the light receiving components 140 and 142.

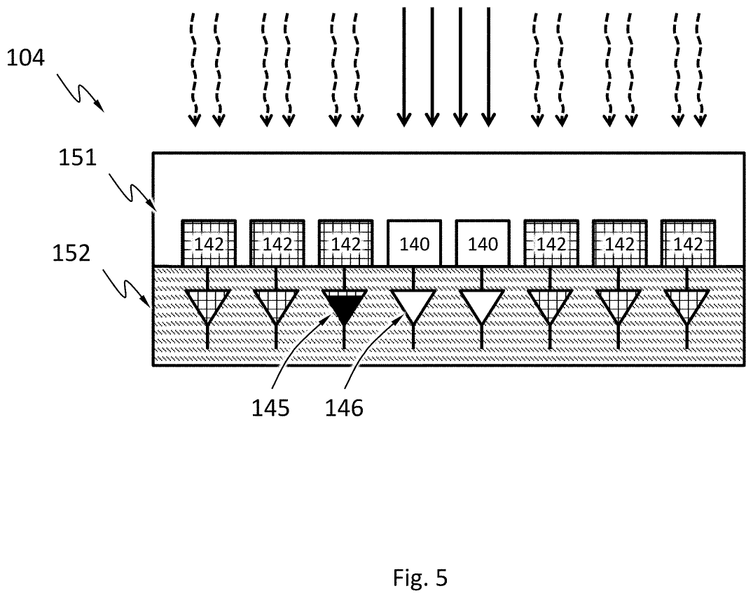

FIG. 5 schematically shows a cross-sectional view of the detector 104, according to an embodiment. The detector may comprise a light receiving layer 151 and an electronics layer 152. The light receiving layer 151 may stack up on top of the electronics layer 152. The first plurality of first light receiving components 140 and the second plurality of light receiving components 142 are inside the light receiving layer 151, according to an embodiment. When the return light of the primary light beam light from the target scene 108 hits the detector 104, the light receiving components 140 may generate charge carriers. The charge carriers may be directed (e.g., under an electric field) to a signal processing unit 145 in the electronics layer 152. When the return light of the diffracted light beams from the target scene 108 hits the detector 104, the light receiving components 142 may generate charge carriers. The charge carriers may be directed (e.g., under an electric field) to a signal processing unit 146 in the electronics layer 152.

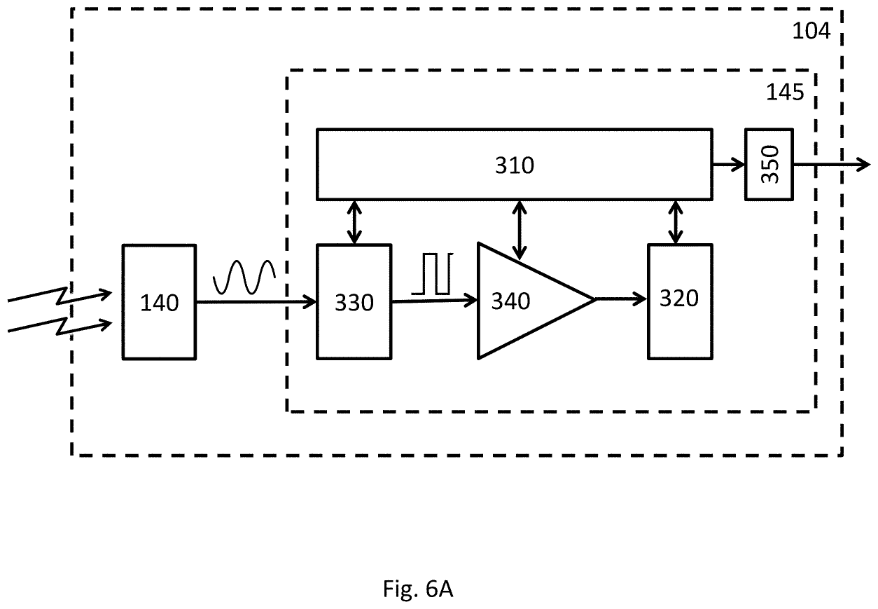

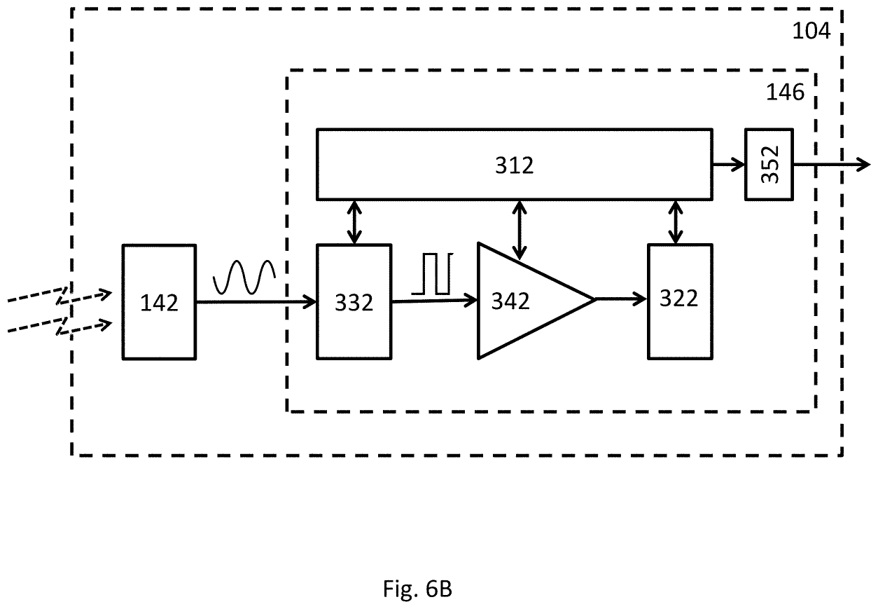

FIG. 6A and FIG. 6B each schematically show a component diagram of the detector 104 comprising the light receiving component 140 and the signal processing unit 145 for return lights of the primary light beam, and the detector 104 comprising the light receiving component 142 and the signal processing unit 146 for return lights of the diffracted light beam, according to an embodiment. The charge carriers generated in the first light receiving component 140 may be converted to a first electrical signal, and the first electrical signal may be transmitted to the signal processing unit 145. The signal processing unit 145 shown in FIG. 6A may be suitable for collecting, processing and interpreting signals generated by incident return light of the primary light beams on the first light receiving component 140 of the detector 104. The signal processing unit 145 may comprise an analog circuitry such as one or more Analog-to-Digital converter modules 330 configured to digitize the first electrical signal, and one or more voltage comparators 340 configured to compare the digitized first electrical signals with reference signals. The signal processing unit 145 may also comprise a digital circuitry such as a microprocessor 310, a memory or a counter 320 configured to register the incident return light of the primary light beams, and a communication module 350 configured to communicate with other circuitry outside the signal processing unit 145, or outside the detector 104.

The charge carriers generated in the second light receiving component 142 may be converted to a second electrical signal, and the second electrical signal may be transmitted to the signal processing unit 146. The signal processing unit 146 shown in FIG. 6B may be suitable for collecting, processing and interpreting signals generated by incident return light of the diffracted light beams on the second light receiving component 142 of the detector 104. The signal processing unit 146 may comprise an analog circuitry such as one or more Analog-to-Digital converter modules 332 configured to digitize the second electrical signal, and one or more voltage comparators 342 configured to compare the digitized second electrical signal with reference signals. The signal processing unit 146 may also comprise a digital circuitry such as a microprocessor 312, a memory or a counter 322 configured to register the incident return light of the diffracted light beams, and a communication module 352 configured to communicate with other circuitry outside the signal processing unit 146, or outside the detector 104.

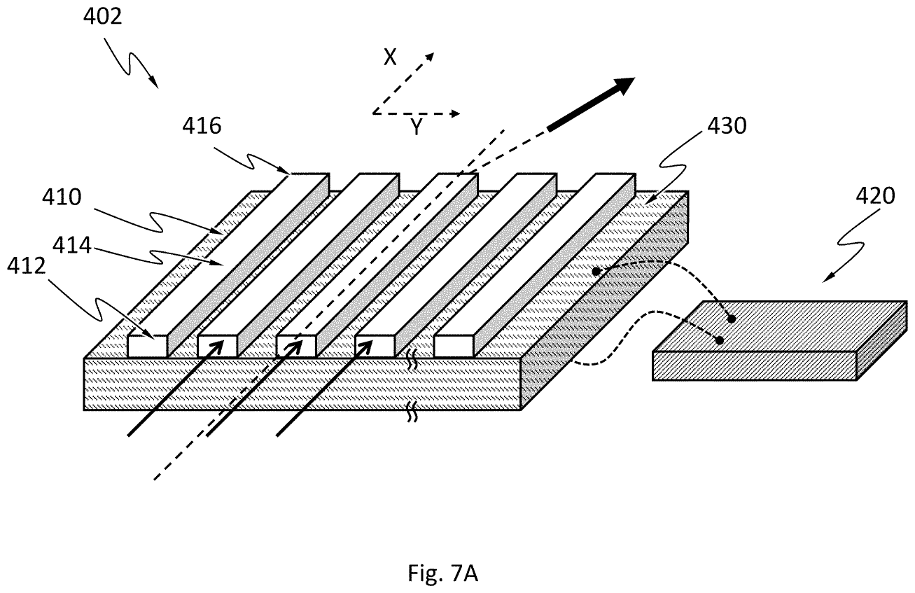

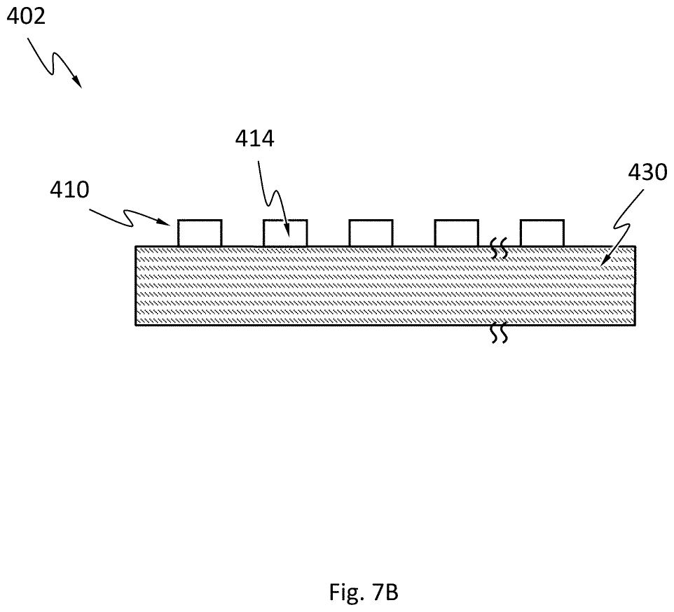

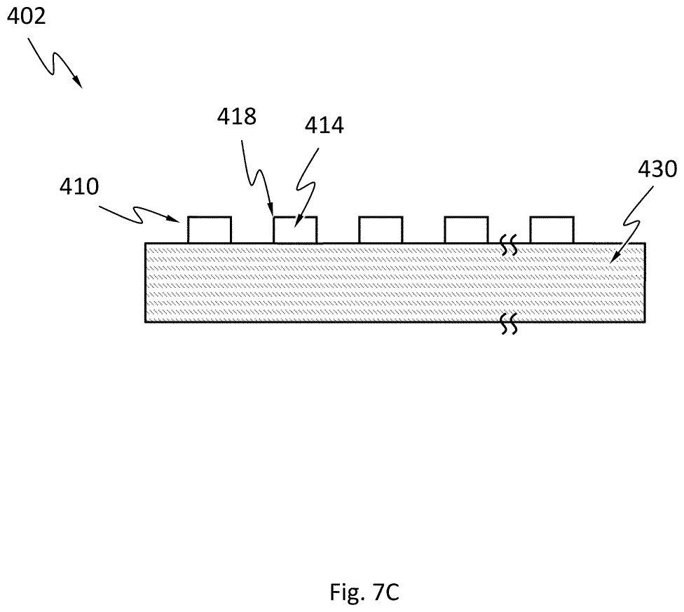

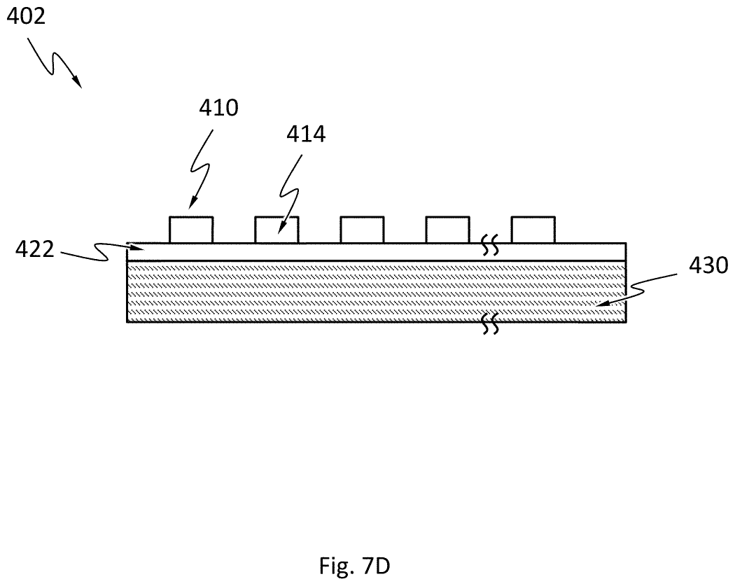

FIG. 7A schematically shows a perspective view of the light steering component 402, according to one embodiment. The light steering component 402 may be an embodiment of the light steering component 204 and may comprise a plurality of optical waveguides 410 and an electronic control system 420. In one embodiment, the plurality of optical waveguides 410 may lie on a surface of a substrate 430. The plurality of optical waveguides 410 may be controlled by the electronic control system 420 to generate a scanning light beam and steer the scanning light beam in the second dimension.

Each of the optical waveguides 410 may comprise an input end 412, an optical core 414 and an output end 416. The optical core 414 may comprise an optical medium. In one embodiment, the optical medium may be transparent. The input ends 412 of the optical waveguides 410 may receive input light waves and the received light waves may pass through the optical cores 414 and exit as output light waves from the output ends 416 of the optical waveguides 410. Diffraction may cause the output light waves from each of the optical cores 414 to spread over a wide angle so that when the input light waves are coherent (e.g., from a coherent light source such as a laser), the output light waves from the plurality of optical waveguides 410 may interfere with each other and exhibit an interference pattern. In one embodiment, the output ends 416 of the plurality of optical waveguides 410 may be arranged to line up in the second dimension. For example, as shown in FIG. 7A, the output ends 416 of the plurality of optical waveguides 410 may be lined up in Y dimension. This way, the output interfaces may face the X direction.

The electronic control system 420 may be configured to control phases of the output light waves from the plurality of optical waveguides 410 for the interference pattern to generate a scanning light beam and steer the scanning light beam in the second dimension. Dimensions of each of the optical cores 414 may be individually adjusted by the electronic control system 420 to control phases of output light waves from respective optical cores 414. The electronic control system 420 may be configured to individually adjust the dimensions of each of the optical cores 414 by regulating the temperature of each of the optical cores 414 respectively.

In an embodiment, the light waves of the input light beam to the plurality of optical waveguides 410 may be at a same phase. The interference pattern of the output light waves from the plurality of optical waveguides 410 may comprise one or more propagating bright spots where output light waves constructively interfere (e.g., re-enforce) and one or more propagating weak spots where output light waves destructively interfere (e.g., cancel out each other). In an embodiment, the one or more propagating bright spots may form one or more scanning light beams. If the phases of the output light beams of the optical cores 414 shift and the phase differences change, the constructive interferences may happen at different directions so that the interference pattern of the output light waves (e.g., the directions of the one or more scanning light beams generated) may also change. In other words, light beam steering in the second dimension may be realized by adjusting the phases of the output light beams from the plurality of optical waveguides 410.

One way of adjusting the phases of the output light waves is changing the effective optical paths of the light waves propagated through the optical cores 414. An effective optical path of a light wave propagated through an optical medium may depend on the physical distance the light travels in the optical medium (e.g., depending on incident angle of the light wave, dimensions of the optical medium). As a result, the electronic control system 420 may adjust the dimensions of the optical cores 414 to change the effective optical paths of incident light beam propagates through the optical cores 414 so that the phases of the output light waves may shift under the control of the electronic control system 420. For example, the length of each of the optical cores 414 may change because at least a part of the respective optical cores 414 has a temperature change. Moreover, the diameter of at least a section of an optical core 414 may change if at least part of the section of the optical core 414 has a temperature change. Therefore, in one embodiment, regulating the temperature of each of the optical cores 414 may be used to control the dimensions of the optical cores 414 (e.g., due to the thermal expansion or contractions of the optical cores 414).

It should be noted that although FIG. 7A shows the plurality of optical waveguides 410 are arranged in parallel, this is not required in all embodiments. In some embodiments, the output ends 416 may be lined up in a dimension but the plurality of optical waveguides 410 need not be straight or be arranged in parallel. For example, in one embodiment, at least one of the optical waveguide 410 may be curved (e.g., “U” shaped, “S” shaped, etc.). The cross-sectional shape of the optical waveguides 410 may be a rectangle, circle, or any other suitable shape. In an embodiment, the plurality of optical waveguides 410 may form a one-dimensional array placed on a surface of the substrate 430 as shown in FIG. 7A. The optical waveguides 410 need not to be evenly distributed in the one-dimensional array. In other embodiments, the plurality of optical waveguides 410 needs not to be on one substrate. For example, some optical waveguides 410 may be on one substrate, some other optical waveguides 410 may be on a separate substrate.

The substrate 430 may include conductive, non-conductive or semiconductor materials. In an embodiment, the substrate 430 may include a material such as silicon dioxide. In an embodiment, the electronic control system 420 may be embedded in the substrate 430 but also may be placed outside of the substrate 430.

In an embodiment, the light source 102 may further comprise a beam expander (e.g., a group of lenses). The beam expander may expand the input light beam before the input light beam enters the plurality of optical waveguides 410. The expanded input light beam may be collimated. In an embodiment, the light source 102 may further comprise a one-dimensional diffraction grating (e.g., a cylindrical microlens array) configured to converge and couple the light waves of the input light beam into the plurality of optical waveguides 410.

FIG. 7B schematically shows a cross-sectional view of the light steering component 402 of FIG. 7A, according to one embodiment. Each of the optical cores 414 may comprise an optical medium that is conductive and transparent. The optical cores 414 may be electrically connected to the electronic control system 420. In an embodiment, the electronic control system 420 may be configured to individually adjust the dimensions of each of the optical cores 414 by individually regulating the temperature of each of the optical cores 414. The electronic control system 420 may apply an electric current to each of the optical cores 414 respectively. The temperature of each of the optical cores 414 may be individually regulated by controlling the magnitude of the electric current flowing through each of the optical cores 414.

FIG. 7C schematically shows a cross-sectional view of the light steering component 402 of FIG. 7A, according to another embodiment. Each of the optical waveguides 410 may comprise a conductive cladding 418 around sidewalls of a respective optical core 414. In an embodiment, each of the conductive claddings 418 may be electronically connected to the electronic control system 420. The electronic control system 420 may be configured to individually adjust the dimensions of each of the optical cores 414 by regulating the temperature of each of the optical cores 414. The electronic control system 420 may apply an electric current to each of the conductive cladding 418. The temperature of each of the optical cores 414 may be regulated individually by controlling the magnitude of each of the electric current flowing through each of the respective conductive cladding 418 due to heat transfer between the optical core 414 and the respective conductive cladding 418.

FIG. 7D schematically shows a cross-sectional view of the light steering component 402 of FIG. 7A, according to an embodiment. The light steering component 402 may comprise one or more temperature modulation elements. A temperature modulation element may convert a voltage or current input into a temperature difference that may be used for either heating or cooling. For example, a temperature modulation element may be a Peltier device. The one or more temperature modulation elements may be able to transfer heat to the plurality of optical waveguides 410. In an embodiment, the one or more temperature modulation elements may be in contact with the plurality of optical waveguides 410. In an embodiment, the one or more temperature modulation elements are electronically connected to the electronic control system 420. The electronic control system 420 may be configured to control the temperature of at least one optical core 414 by adjusting the temperature of the one or more temperature modulation elements due to heat transfer between the plurality of optical waveguides 410 and the one or more temperature modulation elements. In one embodiment, the one or more temperature modulation elements may share a common substrate with the plurality of optical waveguides 410. In example of FIG. 7D, the light steering component 402 comprises a layer 422 comprising the one or more temperature modulation elements on a surface of the substrate 430, and the layer 422 is in contact with the plurality of optical waveguides 410.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An apparatus, comprising:
a light source configured to generate a primary light beam that diverges along a first dimension to illuminate a line in a target scene, and diffracted light beams that diverge along the first dimension and spaced apart from the primary light beam in a second dimension perpendicular to the first dimension;
wherein the light source is configured to scan the primary light beam in the second dimension;
a detector comprising a first plurality of light receiving components configured to detect light of the primary light beam returned from the target scene, and a second plurality of light receiving components configured to detect light of the diffracted light beams returned from the target scene.

2. The apparatus of claim 1, wherein the first plurality of light receiving components are arranged in a first column and the second plurality of light receiving components are arranged in a second column; wherein the first column is parallel to the second column.

3. The apparatus of claim 2, wherein each of the light receiving components is square in shape.

4. The apparatus of claim 1, wherein the first plurality of light receiving components are configured to generate first electrical signals based on the light of the primary light beam returned from the target scene;
wherein the second plurality of light receiving components are configured to generate second electrical signals based on the light of the diffracted light beams returned from the target scene.

5. The apparatus of claim 4, further comprising a signal-processing unit configured to process and analyze the first electrical signals and second electrical signals.

6. An apparatus, comprising:
a light source configured to generate a primary light beam to illuminate a spot in a target scene, and diffracted light beams spaced apart from the primary light beam in a first dimension or a second dimension that is perpendicular to the first dimension;
wherein the light source is configured to scan the primary light beam in the first dimension and the second dimension;
a detector comprising a first light receiving component configured to detect light of the primary light beam returned from the target scene, and a plurality of second light receiving components configured to detect light of the diffracted light beams returned from the target scene.

7. The apparatus of claim 6, wherein the plurality of second light receiving components surround the first light receiving component.

8. The apparatus of claim 6, wherein the first light receiving component is configured to a generate first electrical signal based on the light of the primary light beam returned from the target scene;
wherein the plurality of second light receiving components are configured to generate second electrical signals based on the light of the diffracted light beams returned from the target scene.

9. The apparatus of claim 8, further comprising a signal-processing unit configured to process and analyze the first electrical signals and the second electrical signals.

10. The apparatus of claim 1, wherein the light source comprises a light emitter and a light scanning element, wherein the light scanning element is configured to receive light from the light emitter and generate the primary light beam, wherein the light scanning element is configured to scan the primary light beam in the first dimension or in the second dimension.

11. The apparatus of claim 10, wherein the light scanning element comprises a plurality of optical waveguides and an electronic control system;
wherein the plurality of optical waveguides each comprise an input end, an optical core and an output end, the output ends of the plurality of optical waveguides arranged to line up in the second dimension;
wherein the electronic control system configured to adjust dimensions of the optical cores of the plurality of optical waveguides by regulating temperatures of the optical cores of the plurality of optical waveguides;
wherein by adjusting the dimensions of the optical cores of the plurality of optical waveguides the electronic control system is configured to control phases of output light waves from the plurality of optical waveguides for the output light waves to form the primary light beam and scan the primary light beam in the second dimension.

12. The apparatus of claim 11, wherein at least one optical core comprises an optical medium that is conductive and transparent.

13. The apparatus of claim 12, wherein the at least one optical core is electronically connected to the electronic control system, wherein the electronic control system is configured to control the temperature of at least one optical core by applying an electric current flowing through the at least one optical core.

14. The apparatus of claim 11, wherein at least one of the plurality of optical waveguides further comprises a conductive cladding around sidewalls of a respective optical core.

15. The apparatus of claim 14, wherein the conductive cladding is electronically connected to the electronic control system, wherein the electronic control system is configured to control the temperature of the respective optical core by applying an electric current flowing through the conductive cladding.

16. The apparatus of claim 11, wherein the light scanning element further comprises a temperature modulation element electrically connected to the electronic control system, where in the electronic control system is configured to control the temperature of at least one optical core by adjusting the temperature of the temperature modulation element.

17. The apparatus of claim 16, wherein the temperature modulation element and the plurality of optical waveguides are formed on a common substrate.

18. The apparatus of claim 11, wherein the plurality of optical waveguides is formed on a surface of a common substrate.

19. The apparatus of claim 11, wherein at least one optical waveguide is curved.

20. The apparatus of claim 11, wherein at least one of the plurality of optical waveguides is on one substrate and at least another of the plurality of optical waveguides is on a separated substrate.
